(19) United States
(12) Patent Application Publication
(10) Pub. No.: US 2005/0005456 A1
(43) Pub. Date: Jan. 13, 2005

(54) Blade shaft for scissors

(76) Inventors: Ta-Tieh Wang, Taipei (TW); Chien-Che Huang, Taipei (TW)

Correspondence Address: Ta-Tieh Wang, PO Box 82-144, Taipei, TW

(21) Appl. No.: 10/612,901

(22) Filed: Jul. 7, 2003

(51) Int. Cl. B26B 13/00

(52) U.S. Cl. 30/232; 30/254; 30/341

(57) ABSTRACT

A blade shaft for scissors is disclosed. The end face of the body is provided with screw hole and positioning protrusion, and the end face of the shaft ring body is provided with corresponding slot for a screw rod from the inner edge of the ring body passing through a spring and is locked to the screw hole of the body forming into a controlling buffer when the shaft ring body rotates, by means of the rod element of the shaft body the ring face of the shaft ring body can be rotated to an appropriate angle, and by means of the protrusion and the recess, the blade is positioned at an open angle for hair cutting.

### BACKGROUND OF THE INVENTION

(a) Technical Field of the Invention

The present invention relates to a blade shaft, and in particular, a blade shaft for scissors which allows the shaft ing body to be easily positioned or adjusted during hair-cutting.

(b) Description of the Prior Art

Taiwanese Patent Publication No. 87218399 entitled “Shaft of Blade with Changeable Holding Angle” discloses a blade structure of scissors which can change to an appropriate direction within a specific angle such that the holding of the scissors in operation is adjustable and the hair cutting procedure is smooth.

Conventional scissors have a fixed angle for the blades to open. In operation, force has to be applied to open the blades and at the same time the blades have to be used consistently in order to cut hair. However, the conventional blade shaft is not practical and therefore, it is an object of the present invention to provide a blade shaft for scissors which mitigates the above drawbacks.

### SUMMARY OF THE INVENTION

Accordingly, it is an object of the present invention to provide a shaft for a scissor blade having a blade body and a shaft ring body mounted to form a blade shaft mounting structure, characterized in that the end face of the body is provided with a screw hole and positioning protrusion, and the end face of the shaft ring body is provided with a corresponding slot for a screw rod from the inner edge of the ring body passing through a spring and is locked to the screw hole of the body forming into a controlling buffer when the shaft ring body rotates, by means of the rod element of the shaft body the ring face of the shaft ring body can be rotated to an appropriate angle, and by means of the protrusion and the recess, the blade is positioned at an open angle for hair cutting.

It is another object of the present invention to provide a blade shaft of scissors which allows holding in the course of hair cutting and engaging with the extended ring element of the shaft ring element, and the opening of the blades to an appropriate angle can be easily controlled.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of a blade shaft of the present invention.

FIG. 2 is a perspective view showing the reverse operation and installation of the present invention.

FIG. 3 is a schematic view showing the direction rotation of the shaft ring body to a plan of the present invention.

FIG. 3A is an enlarged view of a portion of FIG. 3.

FIG. 4 is a schematic view showing the direction reverse of the shaft ring to the rear blade and position in accordance with the present invention.

FIG. 4A is an enlarged view of a portion of FIG. 4.

FIG. 5 is a schematic view showing the blade extended to plan view of the present invention.

FIG. 6 is a schematic view showing the use of the blade in hair-cutting in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

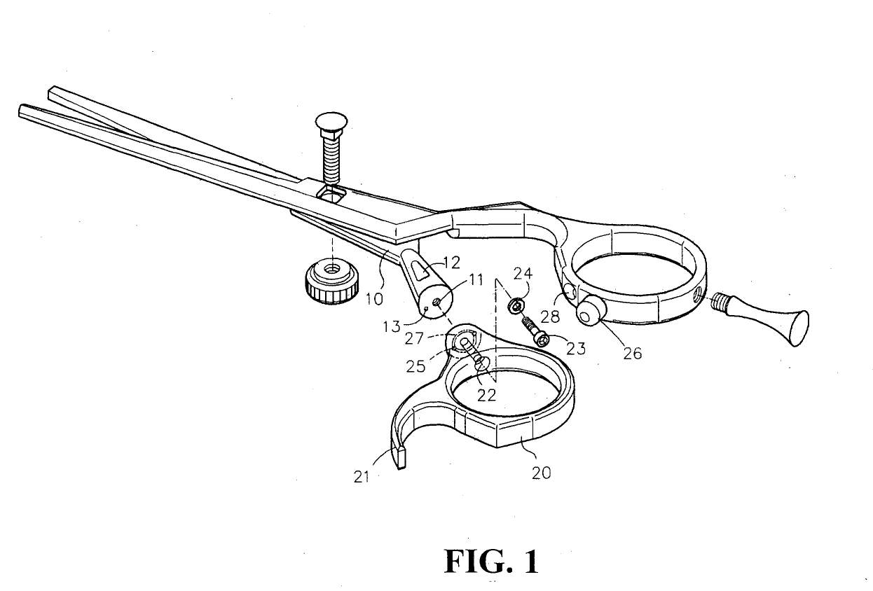

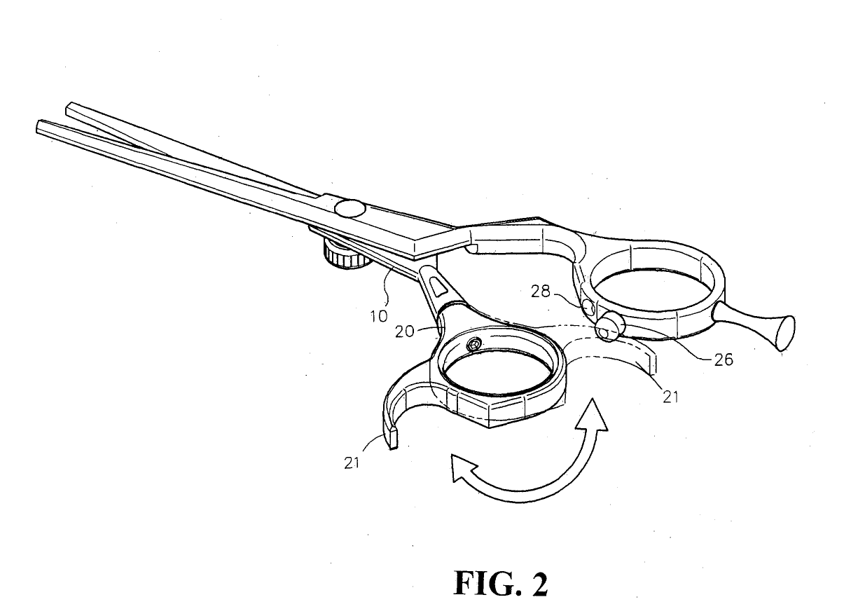

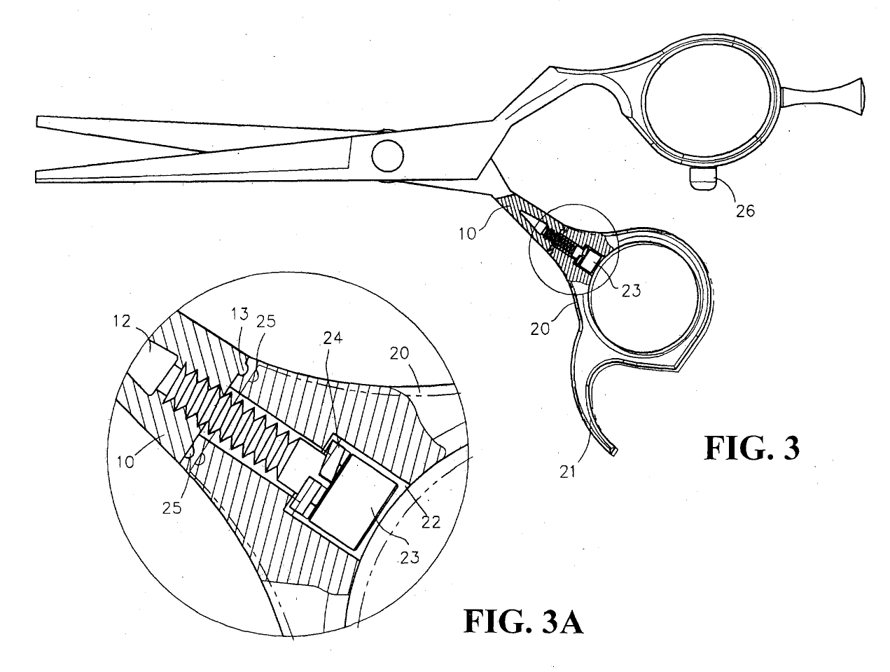

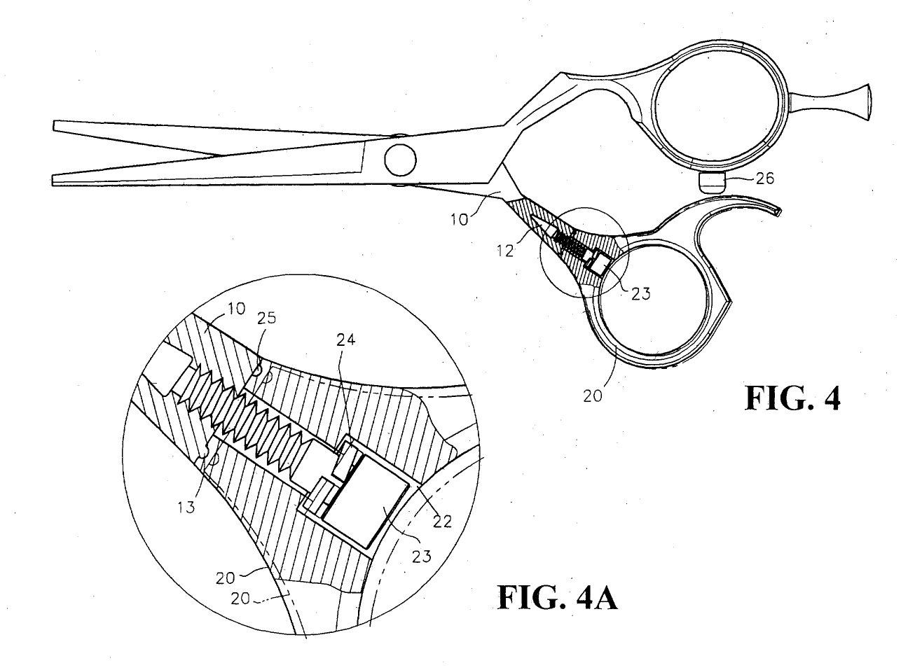

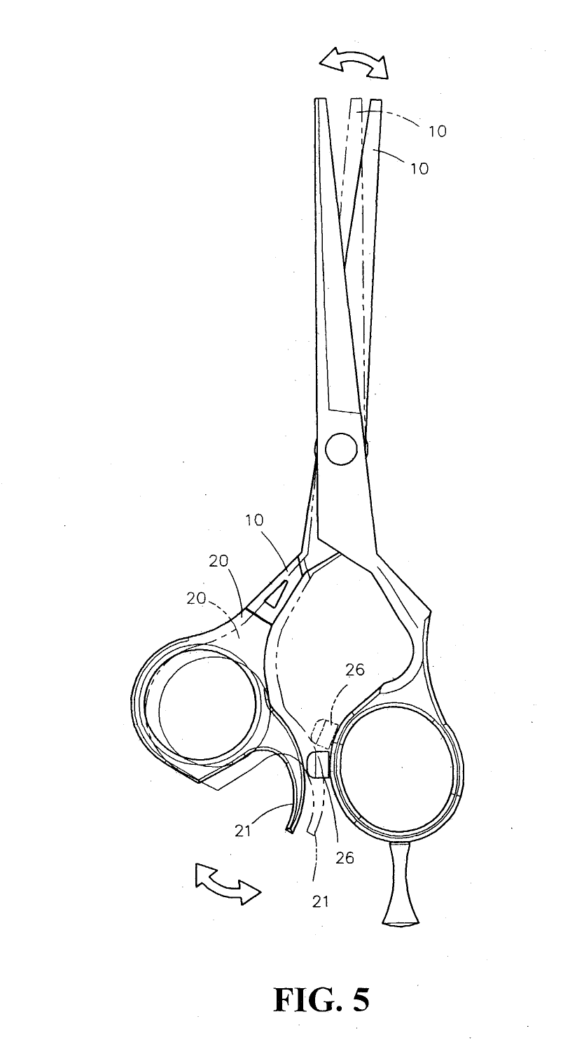

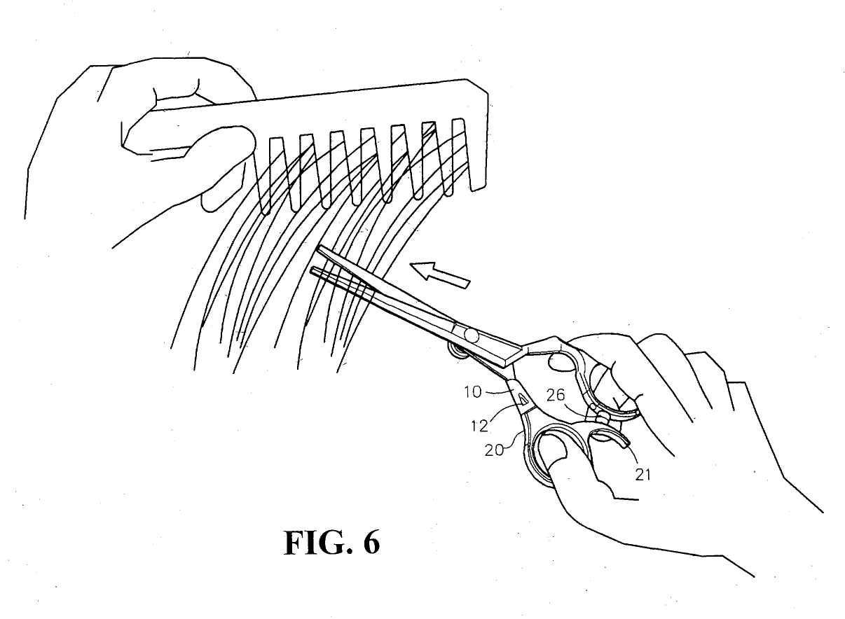

Referring to FIGS. 1 to 6, the scissors having the blade section are divided into a blade body 10 having one end connected to the blade, and the lower section of the blade body 10 connected to a shaft ring body 20. The bottom end face of the blade body 10 is a screw hole 11 for locking and connection. The rod section for connection of the blade is a conic or plate-like shape. The wider blade edge is provided with an inspection hole 12. The end face having the screw hole 11 has a protrusion 13 for positioning. The protrusion 13 can be a protruded point or a higher-angled point. One side of the shaft ring body 20 is extended to form an arch-shaped rod element 21 or directly extending the finger ring edge to an appropriate protruded face so that the two sides of the ring face of the shaft ring body 20 are not corresponding to each other. The end face of the blade body 10 is provided with a stepped through hole 22. After the screw rod 23 is mounted with an elastic element 24, it is directly positioned to the center screw hole 11 of the body 10 and the corresponding rotating ring of the positioning protrusion 13, the two sides can be provided with a recess 25 higher than the protrusion 13 for the mounting of the protrusion 13 so that the shaft ring body 11 is rotatingly controlled and positioned.

In accordance with the present invention, the arch-shaped rod element 21 is engaged with the positioning element 26 so that the blade body 10 is formed into a slanting junction and the blade can be opened, and the opening of the blade can be changed. The arch-shaped rod element 21 can be formed into a protruded frame so that an unsymmetrical engagement with a similar direction in reverse can be obtained.

When the scissors are used to cut hair, the arch-shaped rod element 21 is reversed in direction so that the two inner edge ring faces of the shaft ring body 20 can lean against each other with respect to the positioning element 26. The shaft ring body 20 is pulled downward so that the end faces of the blade body 10 are appropriately separated. The protrusion 13 is at a disengaged position, and the shaft body 20 is reversed for 180 degrees and the rod element 21 is reversed to the inner side face, and the protruded edge and the positioning element 26 are positioned against each other.

For the reverse positioning adjustment of the shaft ring body 20, the protrusion 13 and the recess 25 are in engagement and the connection end face is made into a protruded or recessed shape.

The end face of the shaft ring body 20 has a center through hole 22 as the shaft center. In the course of rotating the protrusion 13 the two connecting end faces do not need to be separated and only need to be provided with a direction change operation. One side of the ring face of the stationery blade is provided with a combination recess 28 such that the positioning element 26 can be engaged at various top and bottom positions enabling the position of the moving blade to be changed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A shaft for a scissor blade having a blade body and a shaft ring body mounted to form a blade shaft mounting structure, characterized in that the end face of the body is provided with a screw hole and positioning protrusion, and the end face of the shaft ring body is provided with a corresponding slot for a screw rod from the inner edge of the ring body passing through a spring and is locked to the screw hole of the body forming into a controlling buffer when the shaft ring body rotates, by means of the rod element of the shaft body the ring face of the shaft ring body can be rotated to an appropriate angle, and by means of the protrusion and the recess, the blade is positioned at an open angle for hair cutting.

2. The blade shaft for scissors of claim 1, wherein the external side of the shaft ring body is protruded from the arch-shaped rod element and the ring body is formed into a protruded body forming an unsymmetrical shape.

3. The blade shaft for scissors of claim 1, wherein the recess on the two sides of the connection end face of the ring body make use of the center through hole to connect with the concentric shape shallow slot.

4. The blade shaft for scissors of claim 1, wherein the connection end face of the blade body and the shaft ring body is formed into a corresponding recess and protrusion edge for mutual insertion.

5. The blade shaft for scissors of claim 1, wherein the ring face of the stationary side is provided with a recess for the insertion of the positioning element to provide changes for the insertion module, facilitating the adjustment of the opening of the scissors blades.
